(19) United States
(12) Patent Application Publication
(10) Pub. No.: US 2026/0319829 A1
(43) Pub. Date: Oct. 15, 2026

(54) DELEGATION OF TIMER INTERRUPT REQUEST HANDLING

(71) Applicant: Ampere Computing LLC, Santa Clara, CA (US)

(72) Inventor: Donald Scott PHILLIPS, Portland, OR (US)

(21) Appl. No.: 19/174,677

(22) Filed: Apr. 9, 2025

(51) Int. Cl. G06F 9/48; G06F 9/455

(52) U.S. Cl. CPC G06F 9/4825; G06F 9/45558; G06F 2009/45579

(57) ABSTRACT

Disclosed is a method of handling interrupt requests (IRQs) performed by a confidential security state controller, comprising determining, after a confidential security state exit of a virtual machine (VM), whether a pending IRQ is a timer IRQ with a VM-level processor privilege; based on the pending IRQ being the timer IRQ with the VM-level processor privilege, activating the timer IRQ in a per-processor interrupt routing infrastructure (IRI); and returning control to the VM.

### BACKGROUND OF THE DISCLOSURE

Aspects of the disclosure relate generally to handling of timer interrupt requests (IRQs). More specifically, but not exclusively, to delegation of timer IRQ handling to a confidential security state controller for enhanced efficiency.

Traditional security measures, like encryption, conventionally protect data while in storage (e.g., in memory) or in transit (e.g., during communication). Confidential and secure processing environments have been introduced to ensure that data is protected during active use (e.g., processing).

Some architectures (e.g., a confidential compute architecture (CCA)) use virtual machines (VMs) to process sensitive data. The architecture may include a computer having one or more processors/processor cores and a host operating system. Within the architecture, a VM monitor (e.g., a hypervisor) may create and manage one or more VMs.

For sensitive data, the architecture may provide a trusted execution environment that includes special VMs that provide heightened data security (e.g., realm VMs). These VMs have special safeguards in place for ensuring data confidentiality and integrity, and are co-managed by a confidential security state controller (e.g., a realm management monitor (RMM)). The architecture may implement a trust boundary that isolates these VMs from other VMs, the hypervisor, and/or the host operating system (OS).

In a scenario with multiple VMs, timer interrupts may be necessary to manage resources. For example, when a timer interrupt occurs during execution of a VM, the VM will exit to the confidential security state controller, and the confidential security state controller will exit to the host OS. The host OS and/or hypervisor may determine whether to perform resource management (e.g., reallocation of the resources to a different VM). Often, reallocation will not be performed, and control will return to the VM via the confidential security state controller. However, timer interrupts may occur frequently (e.g., up to one hundred times per second per core), thereby reducing the efficiency of the host OS. Moreover, while the host OS is handling the interrupts, the VM cannot process data.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of handling interrupt requests (IRQs) performed by a confidential security state controller comprises determining, after a confidential security state exit of a virtual machine (VM), whether a pending IRQ is a timer IRQ with a VM-level processor privilege, based on the pending IRQ being the timer IRQ with the VM-level processor privilege, activating the timer IRQ in a per-processor interrupt routing infrastructure (IRI), and returning control to the VM.

In an aspect, a confidential security state controller comprises one or more processors configured, either alone or in combination, to determine, after a confidential security state exit of a virtual machine (VM), whether a pending IRQ is a timer IRQ with a VM-level processor privilege, based on the pending IRQ being the timer IRQ with the VM-level processor privilege, activating the timer IRQ in a per-processor interrupt routing infrastructure (IRI), and return control to the VM.

In an aspect, a confidential security state controller comprises means for determining, after a confidential security state exit of a virtual machine (VM), whether a pending IRQ is a timer IRQ with a VM-level processor privilege, based on the pending IRQ being the timer IRQ with the VM-level processor privilege, activating the timer IRQ in a per-processor interrupt routing infrastructure (IRI), and means for returning control to the VM.

In an aspect, a non-transitory computer-readable medium stores computer-executable instructions that, when executed by a confidential security state controller, cause the confidential security state controller to determine, after a confidential security state exit of a virtual machine (VM), whether a pending IRQ is a timer IRQ with a VM-level processor privilege, based on the pending IRQ being the timer IRQ with the VM-level processor privilege, activating the timer IRQ in a per-processor interrupt routing infrastructure (IRI), and return control to the VM.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example of a confidential compute architecture (CCA), according to aspects of the disclosure.

FIG. 2 illustrates an example of realm exit paths within a CCA, according to aspects of the disclosure.

FIG. 3 illustrates a signal flow diagram for handing one or more interrupt requests (IRQs) within a computer architecture, in accordance with aspects of the disclosure.

FIG. 4 illustrates a signal flow diagram for exchanging and/or implementing capabilities of a confidential security state controller within a computer architecture, in accordance with aspects of the disclosure.

FIG. 5 illustrates a flow chart of a method performed at a confidential security state controller, according to aspects of the disclosure.

### DETAILED DESCRIPTION

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

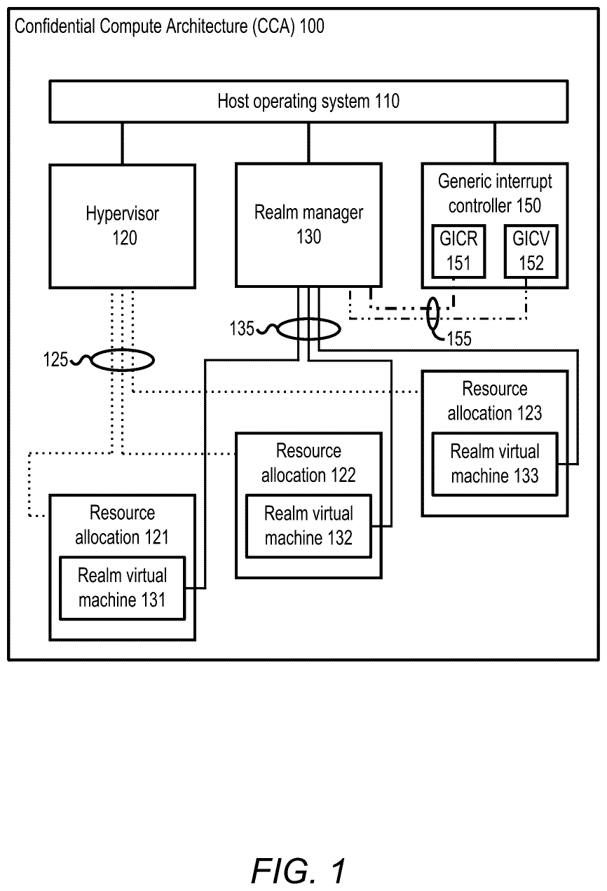

FIG. 1 illustrates an example of a computer architecture, according to aspects of the disclosure. In the illustrated example, the computer architecture is a confidential compute architecture (CCA) 100. The CCA 100 may be associated with an advanced reduced instruction set computing machine (ARM) architecture.

The CCA 100 comprises a host operating system (OS) 110. Host OS 110 may be responsible for managing the overall hardware and software operations in the CCA 100. Host OS 110 may oversee the components of the CCA 100.

The CCA 100 comprises a hypervisor 120. Hypervisor 120 may manage virtualization of one or more virtual machines (VMs) in the CCA 100. Hypervisor 120 may enable multiple VMs to run on a single physical machine by allocating resources such as memory and processor time. Hypervisor 120 may manage the resource allocations via an interface 125. Hypervisor 120 may manage resource allocations 121, 122, and 123, which contain resources allocated to different VMs. In the illustrated example, the VMs comprise realm VMs 131, 132, 133. Each VM may operate independently, utilizing the resources assigned by hypervisor 120. Realm VMs 131, 132, 133 may run in protected environments to ensure security and confidentiality. Hypervisor 120 may be isolated from realm VMs 131, 132, 133 and may be unable to access data within the realm VMs 131, 132, 133.

The CCA 100 comprises a confidential security state controller. In the illustrated example, the confidential security state controller is a realm management monitor (RMM) 130. RMM 130 may be responsible for managing the realm VMs. RMM 130 may manage the VMs via an interface 135. RMM 130 may handle a lifecycle of each realm VM, from creation to termination. RMM 130 may ensure compliance with the confidential computing requirements of CCA 110.

The CCA comprises an interrupt routing infrastructure (IRI). In the illustrated example, the IRI is a generic interrupt controller (GIC) 150. Hypervisor 120 and RMM 130 may interact with GIC 150 to manage interrupts that affect the VMs. GIC 150 may be responsible for managing interrupts in the CCA 100.

The IRI may comprise a per-processor, per-processor core, and/or per-core IRI. For brevity and ease of illustration, in the remainder of the present disclosure, “per-core” will be used as shorthand for, and should be considered as interchangeable with, “per-processor, per-processor core, and/or per-core.” In the illustrated example, the per-core IRI is a GIC redistributor (GICR) 151. The GICR 151 may distribute interrupts to individual processors/cores in the CCA 100. In an example, each processor/core is associated with an instance of the redistributor, allowing GICR 151 to route interrupts to the correct processor/core based on various configurations and priorities.

The IRI may comprise a per-core interrupt virtualization state. In the illustrated example, the per-core interrupt virtualization state is a GIC virtualization (GICV) 152. The GICV 152 may allow each VM to interact with virtual interrupts. For example, when an interrupt is generated by physical hardware, the GIC 150, via the GICR 151, may deliver the interrupt to an appropriate processor/core. Based on the interrupt, a virtual interrupt may be delivered to an appropriate VM via GICR 151, RMM 130, and/or GICV 152. For example, the interrupt may be delivered through the GICR 151 to the RMM 130, and the RMM 130 may use the GICV 152 to deliver the interrupt to the appropriate VM. In an example, the virtual interrupt may be visible to the appropriate VM, and transparent to other VMs.

In accordance with aspects of the disclosure, the confidential security state controller (e.g., RMM 130) and the IRI (e.g., GIC 150) may interact via an interface 155. For example, the confidential security state controller may interact with either or both of the per-core IRI (e.g., GICR 151) and the per-core interrupt virtualization state (e.g., GICV 152).

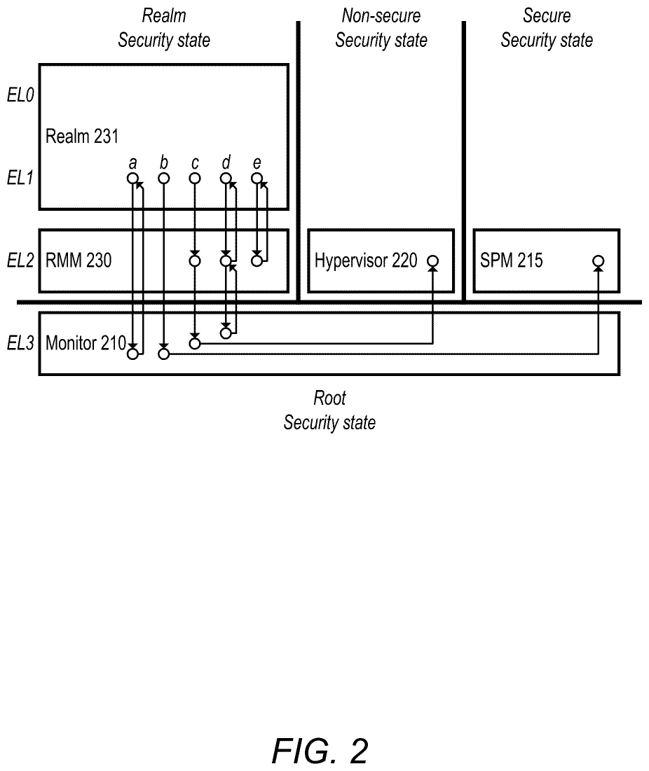

FIG. 2 illustrates an example of exit paths within a computer architecture, according to aspects of the disclosure. In the illustrated example, components of a CCA (analogous to CCA 100) correspond to different security states and processor privilege levels.

The security states are represented as realm security state, non-secure security state, secure security state, and root security state. The processor privilege levels are represented as exception level zero (EL0), exception level one (EL1), exception level two (EL2), and exception level three (EL3). In the illustrated example, EL0 represents the lowest processor privilege level, and EL3 represents the highest processor privilege level.

Within the realm security state, a realm 231 operates at EL0 and EL1. Realm 231 may correspond to the VMs (e.g., realm VM 131, 132, 133) described above. An RMM 230 operates at EL2. RMM 230 may be analogous to the confidential security state controller (e.g., RMM 130) described above. A monitor 210 operates at EL3. Monitor 210 may correspond to the host OS 110 described above. Monitor 210 exists in the root security state.

In the illustrated example, several realm exit paths labeled a through e demonstrate transitions from the realm security state to other levels of the system. Exit path a represents a transition from EL0/EL1 in realm 231 to EL3 in monitor 210. Exit path b represents a transition from EL0/EL1 in realm 231 to EL3 in monitor 210, followed by a transition to secure partition manager (SPM) 215. SPM 215 operates at EL2 in the secure security state. An SPM is a software component which is responsible for the management of secure partitions. A secure partition may contain a trusted operating system. SPM may operate in the secure security state and may not be directly related to CCA. Exit path c represents a transition from EL0/EL1 to EL2 in RMM 230, followed by a transition to EL3 in monitor 210, followed by a transition to a hypervisor 220. Hypervisor 220 operates at EL2 in the non-secure security state.

Exit path d represents a transition from EL0/EL1 to EL2 in RMM 230, followed by a transition to EL3 in monitor 210, followed by a return to RMM 230, and a return to realm 231. Exit path e represents a transition from EL0/EL1 to EL2 in RMM 230, followed by a return to realm 231.

When a timer interrupt request (IRQ) occurs during execution of a VM (e.g., a realm VM), exit will typically occur along a path from realm 231 to RMM 230 to monitor 210 and to hypervisor 220, before returning along the same path (hypervisor 220 to monitor 210 to RMM 230 to realm 231). In particular, the VM will exit to the confidential security state controller (e.g., EL2), and the confidential security state controller will exit to the host OS (e.g., EL3). At EL3, the host OS (and/or hypervisor) may handle the IRQ. For example, the host OS (and/or hypervisor) may determine whether to perform resource management (e.g., reallocation of the resources to a different VM). Often, reallocation will not be performed, and control will return to the VM via the confidential security state controller. However, timer interrupts may occur frequently (e.g., one hundred times per second per core), thereby reducing the efficiency of the host OS. Moreover, while control is passed to EL2 and then EL3 before returning to EL2 and then EL1, the VM cannot process data.

In accordance with aspects of the disclosure, timer interrupt requests (IRQs) may be handled by a confidential security state controller (e.g., similar to RMM 130 and/or RMM 230). For example, the confidential security state controller may determine, after a confidential security state exit of a VM (e.g., similar to realm VM 131, 132, 133 and/or realm 231), whether a pending IRQ is a timer IRQ with a VM-level processor privilege (e.g., similar to EL0 and/or EL1). Based on the pending IRQ being a timer IRQ with the VM-level processor privilege, the confidential security state controller may activate the timer IRQ in a per-processor IRI (e.g., similar to GICR 151) and return control to the VM.

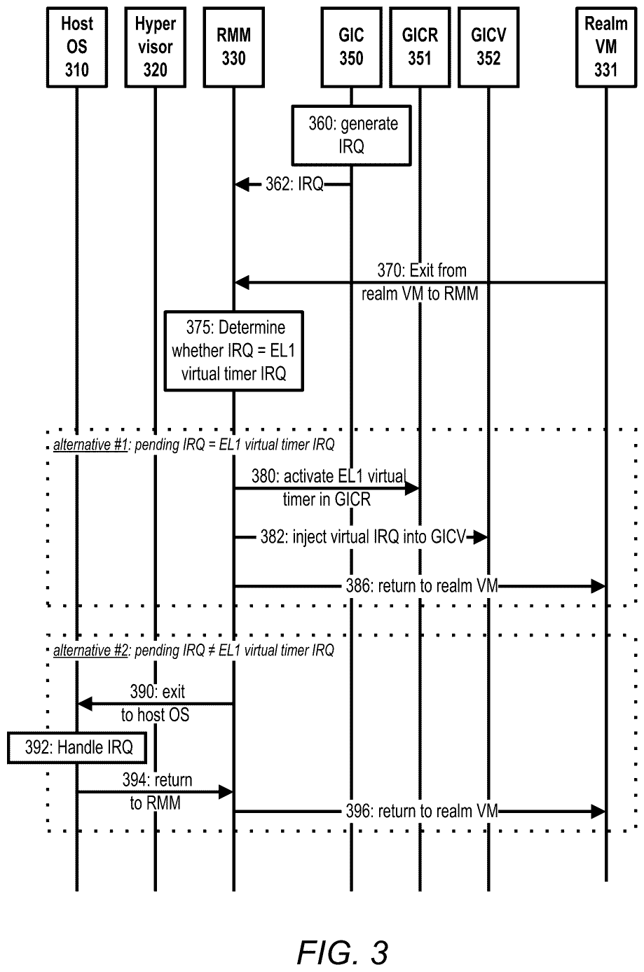

FIG. 3 illustrates a signal flow diagram for handling one or more IRQs within a computer architecture, in accordance with aspects of the disclosure.

The computer architecture comprises: a host OS 310 (e.g., analogous to host OS 110 described above); a hypervisor 320 (e.g., analogous to hypervisor 120 described above); a confidential security state controller, represented in the illustration as an RMM 330 (e.g., analogous to the RMM 130 described above); an interrupt routing infrastructure (IRI), represented in the illustration as a GIC 350 (e.g., analogous to the GIC 150 described above); a per-core IRI, represented in the illustration as a GICR 351 (e.g., analogous to the GICR 151 described above); a per-core interrupt virtualization state, represented in the illustration as a GICV 352 (e.g., analogous to the GICV 152 described above); and a virtual machine, represented in the illustration as a realm VM 331 (e.g., analogous to the realm VMs 131, 132, 133 described above).

At 360, GIC 350 generates an IRQ (interrupt request) to signal an event requiring the attention of the computer architecture. For example, an interrupt may be caused by physical hardware associated with the computer architecture (e.g., a drive, a network card, etc.). The GIC 350 may direct the IRQ to an appropriate recipient. In an example, the IRQ may be a timer IRQ and/or a virtual timer IRQ. In an example, the IRQ may be associated with a VM-level processor privilege and/or exception level one (EL1).

At 362, GIC 350 sends the IRQ to RMM 330. The IRQ may be delivered in a current execution state of the IRQ.

At 370, realm VM 331 exits. The exit may be a realm exit to RMM 330. The exit may occur autonomously (e.g., by hardware). After the exit, realm VM 331 may stop processing of data within realm VM 331. For example, realm VM 331 may not restart processing of the data until control returns to realm VM 331.

At 375, RMM 330 determines a type, category, or privilege level of the IRQ. RMM 330 may check a highest-priority pending IRQ to determine the type, category, or privilege level. In an example, the highest-priority pending IRQ may be presented to a central processing unit of the computer architecture. In an example, the highest-priority pending IRQ may be stored in a register of the IRI (e.g., GIC 350), and the RMM 330 may access the IRI in order to determine the type, category, or privilege level of the IRQ. The determining may be based on (e.g., prompted by) the exit of realm VM 331.

In accordance with aspects of the disclosure, the confidential security state controller (e.g., RMM 330) may determine, based on the type, category, or privilege level of the IRQ, whether to (1) handle the IRQ itself or (2) exit to host OS 310 and/or to a higher processor privilege level. In an example, handling of the IRQ by the confidential security state controller (e.g., RMM 330) may have benefits to the host OS 310, the realm VM 331, and/or other components of the computer architecture. For example, if RMM 330 handles the IRQ, then RMM 330 may not need to exit to host OS 310, and host OS 310 may not be required to divert resources to IRQ handling. For example, if RMM 330 handles the IRQ, then an exit from RMM 330 to host OS 310 and corresponding return from host OS 310 to RMM 330 may not be necessary, and control may return to realm VM 331 more quickly.

In accordance with aspects of the disclosure, RMM 330 may handle the IRQ based on the IRQ being a timer IRQ and/or a virtual timer IRQ. Additionally or alternatively, RMM 330 may handle the IRQ based on the IRQ being at or below a particular privilege level (e.g., VM-level processor privilege level and/or exception level one (EL1)).

Different RMMs support different capabilities, and some RMMs may not support IRQ handling. In accordance with aspects of the disclosure, RMM 330 supports an IRQ handling capability, and may handle the IRQ based on the support (e.g., a capability of handling IRQs associated with timer IRQs, virtual timer IRQs, a particular privilege level, etc.).

Host OS 310 (or some other component of the computer architecture) may determine to enable or disable the capabilities of RMM 330. In accordance with aspects of the disclosure, RMM 330 may handle the IRQ based on the IRQ handling capability of the RMM 330 being enabled (e.g., enabled by host OS 310, etc.).

At 375, RMM 330 determines whether a pending IRQ has a particular type, category, and/or privilege level. In the illustrated example, the type, category, and/or privilege level of the pending IRQ corresponds to an EL1 virtual timer IRQ.

In the illustrated example, RMM 330 determines whether to handle a pending IRQ based on whether the pending IRQ has the particular type, category, and/or privilege level (e.g., EL1 virtual timer IRQ). If the pending IRQ is an EL1 virtual timer IRQ (“alternative #1” in the illustration), then performance begins at 380, as will be discussed in greater detail below. If the pending IRQ is not an EL1 virtual timer IRQ (“alternative #2” in the illustration), then performance begins at 390, as will be discussed in greater detail below. Although a particular type of interrupt (EL1 virtual timer IRQ) is discussed here, it will be understood that the techniques discussed herein may be applied to other interrupts, for example, certain types of per-processor interrupt such as a processor's performance monitoring unit overflow interrupt.

At 380 (the beginning of “alternative #1” in FIG. 3), RMM 330 activates the IRQ in a per-core IRI. In the illustration, the per-core IRI is represented by GICR 351. In accordance with aspects of the disclosure, RMM 330 activates the IRQ via memory-mapped register access to the GICR 351. In accordance with aspects of the disclosure, the register access may be via an interface between RMM 300 and GICR 351 (e.g., analogous to the interface 155 or a component thereof).

At 382, RMM 330 injects a virtual IRQ into a per-processor interrupt virtualization state. In the illustration, the per-processor interrupt virtualization state is represented by GICV 352. In accordance with aspects of the disclosure, RMM 330 injects the virtual IRQ via a register of a central processing unit associated with the computer architecture.

It will be understood that RMM 300 may perform the activating at 380, the injecting at 382, or both, in any order. It will be understood that based on determining to handle the pending IRQ at 375, RMM 300 may perform the activating at 380, the injecting at 382, or both, in any order.

At 386, control returns to realm VM 331 from RMM 330. The returning at 386 may follow the activating at 380, the injecting at 382, or both. In accordance with aspects of the disclosure, from the time of the realm exit at 370 to the time of the return at 380, RMM 330 does not exit to host OS 310. In an example, by avoiding the exit to host OS 310, control is returned to realm VM 331 relatively quickly, and the overall speed of the computer architecture may increase.

A single processor may be in various states associated with host OS 310, hypervisor 320, RMM 330, and realm VM 331. As events like ‘exit’ and ‘return’ occur, the processor may transition between states.

In accordance with aspects of the disclosure, the returning at 386 may be based on a determination by the RMM 330 that there is no new pending IRQ. If there is a new pending IRQ, then the RMM 330 may return to 375 to determine if the new pending IRQ has the particular type, category, and/or privilege level (not illustrated).

At 390 (the beginning of “alternative #2” in FIG. 3), RMM 330 exits. The exit may be to host OS 310. The exit may be based on the determining at 375.

At 392, host OS 310 handles the IRQ. Host OS 310 allocates resources to the IRQ handling, which could have been usefully allocated elsewhere if the host OS 310 were not handling the IRQ.

At 394, control returns to RMM 330 from host OS 310. The returning at 394 may be based on completion (e.g., successful completion) of the IRQ handling at 392. In accordance with aspects of the disclosure, the returning at 394 may be based on a determination by the host OS 310 that there is no new pending IRQ. If there is a new pending IRQ, then the host OS 310 may handle the new pending IRQ and/or delegate handling of the new pending IRQ to RMM 330.

At 396, control returns to realm VM 331 from RMM 330. In accordance with aspects of the disclosure, the returning at 396 may be based on a determination by the RMM 330 that there is no new pending IRQ. If there is a new pending IRQ, then the RMM 330 may instead return to 375 to determine if the new pending IRQ has the particular type, category, and/or privilege level (not illustrated).

The EL1 virtual timer IRQ has a high frequency of interrupts, and generates high levels of overhead, and so FIG. 3 illustrates a technique for handling such interrupts. However, it will be understood that the techniques illustrated in FIG. 3 may be applied to any interrupt that the host OS 310 delegates to the realm VM 331, and doesn't need to be involved with for correctness.

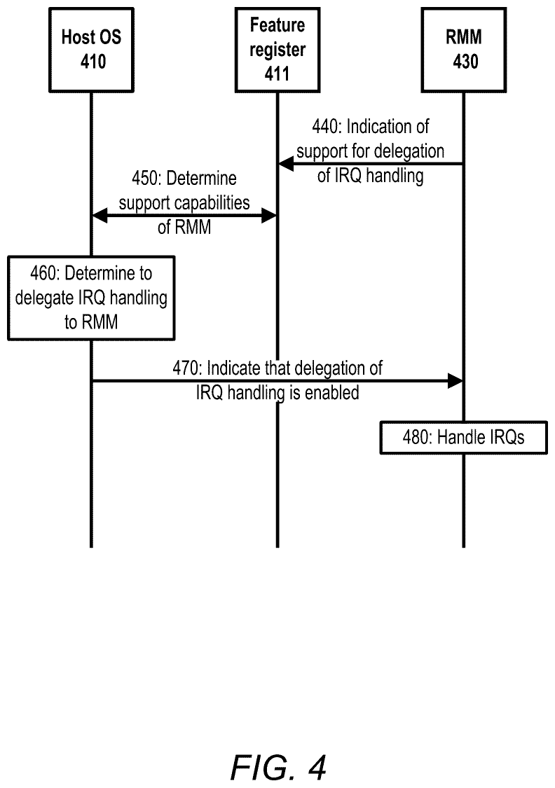

FIG. 4 illustrates a signal flow diagram for exchanging and/or implementing capabilities of a confidential security state controller within a computer architecture, in accordance with aspects of the disclosure.

The computer architecture comprises: a host OS 410 (e.g., analogous to host OS 110 or host OS 310 described above); a feature register 411; and a confidential security state controller, represented in the illustration as an RMM 430 (e.g., analogous to RMM 130 or RMM 330 described above).

As noted above, different RMMs support different capabilities, and some RMMs may not support IRQ handling (e.g., delegation of IRQ handling). In accordance with aspects of the disclosure, RMM 430 may handle IRQs having a particular type, category, and/or privilege level (e.g., timer IRQs, virtual timer IRQs, IRQs at or below a particular processor privilege level, etc.).

At 440, RMM 430 indicates support for delegation of IRQ handling. Delegation may refer to host OS 310 allowing RMM 330 to perform the procedures associated with alternative #1 (as illustrated in FIG. 3). For example, if host OS 310 does not indicate that IRQ handling is delegated, then alternative #2 (as illustrated in FIG. 3) may occur for all IRQs. In accordance with aspects of the disclosure, the IRQs for which RMM 430 supports delegation may be associated with a particular type, category, and/or privilege level (e.g., EL1 virtual timer IRQs as described in FIG. 3). For example, RMM 430 may advertise support for IRQ delegation generally, or support for particular IRQs, or support for particular types, categories, or privilege levels of IRQs.

The indicating at 440 may be directed to a feature register 411. The feature register 411 may be a realm management interface (RMI) feature register (RmiFeatureRegister). The feature register 411 may be accessible to the host OS 410. The feature register 411 may write, store, and/or maintain capability information pertaining to one or more capabilities of the RMM 430 and/or one or more other components of the computer architecture. The capability information may pertain to support for delegation of IRQ handling and other CPU features.

At 450, host OS 410 and/or feature register 411 may determine the support capabilities of RMM 430. For example, host OS 410 may access capability information written, stored and/or maintained in feature register 411 to determine the support capabilities associated with RMM 430.

At 460, host OS 410 may determine to delegate IRQ handling to RMM 430. In accordance with aspects of the disclosure, the determining to delegate at 460 may be based on the RMM 430 supporting delegation of IRQ handling (e.g., based on the capability information stored in the feature register 411). In accordance with aspects of the disclosure, the determining to delegate at 460 may be based on a default rule, a user configuration of the host OS 410 and/or RMM 430, low availability of resources available to host OS 410, etc.

At 470, host OS 410 indicates to RMM 430 that delegation of IRQ handling is enabled. The indicating at 470 may be via one or more RMI realm parameter flags (e.g., RmiRealmParams). In accordance with aspects of the disclosure, host OS 410 may indicate that handling of one or more particular IRQs is enabled (e.g., IRQs associated with a particular type, category, and/or privilege level).

At 480, RMM 430 handles one or more IRQs. In accordance with aspects of the disclosure, the handling may be based on the receiving at 470 of the indication that delegation of IRQ handling is enabled. In accordance with aspects of the disclosure, the handling may be based on an IRQ being associated with a particular type, category, and/or privilege level for which delegation of IRQ handling is enabled. It will be understood that the handling at 480 performed by RMM 430 may be analogous to the performance of the RMM 330 illustrated in FIG. 3.

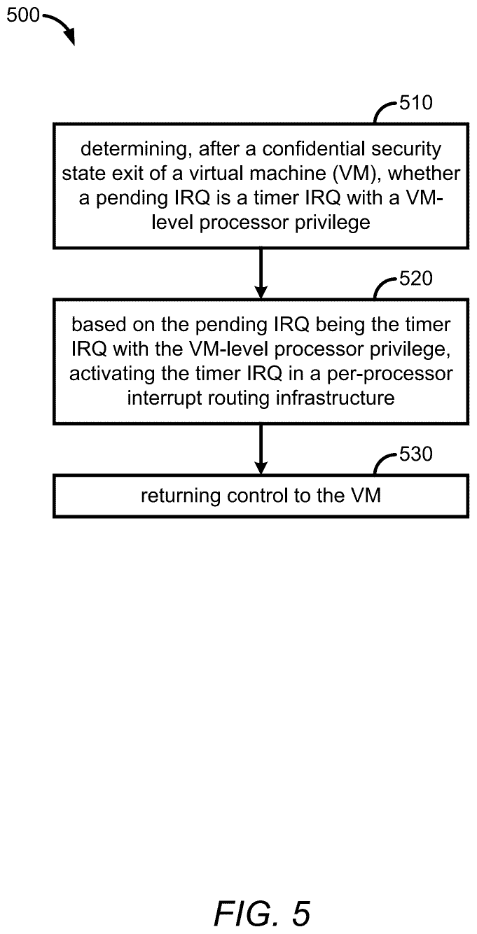

FIG. 5 illustrates a flow chart of a method 500 performed at a confidential security state controller (e.g., an RMM such as RMM 130, RMM 330, RM 430), in accordance with aspects of the disclosure. In some implementations, one or more process blocks of FIG. 5 may be performed by an RMM (e.g., RMM 130, RMM 230, RMM 330, RMM 430). In some implementations, one or more process blocks of FIG. 5 may be performed by another device or a group of devices separate from or including the confidential security state controller. Additionally, or alternatively, one or more process blocks of FIG. 5 may be performed by one or more components of one or more processors, any or all of which may be means for performing the operations of method 500.

As shown in FIG. 5, method 500 may include, at operation 510, determining, after a confidential security state exit of a virtual machine (VM), whether a pending IRQ is a timer IRQ with a VM-level processor privilege. Means for performing operation 510 may include a confidential security state controller, RMM 130, RMM 230, RMM 330, RMM 430, or one or more components of a computer architecture that, alone or in combination, perform the functions of a confidential security state controller or RMM.

As further shown in FIG. 5, method 500 may include, at operation 520, activating the timer IRQ in a per-processor interrupt routing infrastructure based on the pending IRQ being the timer IRQ with the VM-level processor privilege. Means for performing operation 520 may include a confidential security state controller, RMM 130, RMM 230, RMM 330, RMM 430, or one or more components of a computer architecture that, alone or in combination, perform the functions of a confidential security state controller or RMM.

As further shown in FIG. 5, method 500 may include, at operation 530, returning control to the VM. Means for performing operation 530 may include a confidential security state controller, RMM 130, RMM 230, RMM 330, RMM 430, or one or more components of a computer architecture that, alone or in combination, perform the functions of a confidential security state controller or RMM.

Method 500 may include additional implementations, such as any single implementation or any combination of implementations described below and/or in connection with one or more other processes described elsewhere herein.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended. Furthermore, it is also intended that aspects of a clause can be included in any other independent clause, even if the clause is not directly dependent on the independent clause.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Aspects of the present disclosure are illustrated in the description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims. In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or one or more claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim. It should furthermore be noted that methods, systems, and apparatus disclosed in the description or in the claims can be implemented by a device comprising means for performing the respective actions and/or functionalities of the methods disclosed. Furthermore, in some examples, an individual action can be subdivided into one or more sub-actions or contain one or more sub-actions. Such sub-actions can be contained in the disclosure of the individual action and be part of the disclosure of the individual action. While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A confidential security state controller comprising:
one or more processors configured, either alone or in combination, to:
determine, after a confidential security state exit of a virtual machine (VM), whether a pending IRQ is a timer IRQ with a VM-level processor privilege;
based on the pending IRQ being the timer IRQ with the VM-level processor privilege, activate the timer IRQ in a per-processor interrupt routing infrastructure (IRI); and
return control to the VM.

2. The confidential security state controller of claim 1, wherein the per-processor IRI is associated with a central processing unit (CPU), and activating the timer IRQ is via memory-mapped register access to the per-processor IRI.

3. The confidential security state controller of claim 1, wherein:
based on the pending IRQ being caused by the timer, an exception caused by the pending IRQ is handled by the confidential security state controller, and does not return execution to a host operating system.

4. The confidential security state controller of claim 1, wherein the one or more processors, either alone or in combination, are further configured to:
based on the pending IRQ not being caused by the timer, exiting to a host operating system.

5. The confidential security state controller of claim 1, wherein the one or more processors, either alone or in combination, are further configured to:
based on the pending IRQ being caused by the timer, injecting a virtual IRQ into a per-processor interrupt virtualization state.

6. The confidential security state controller of claim 5, wherein the per-processor interrupt virtualization state is associated with a central processing unit (CPU) of the CCA, and the injecting is via a register of the CPU.

7. The confidential security state controller of claim 1, wherein:
after activating the timer IRQ in the per-processor IRI, there is no new pending IRQ; and
return control to the VM is based on there being no new pending IRQ.

8. The confidential security state controller of claim 1, wherein the pending IRQ is a highest-priority pending IRQ presented to a central processing unit (CPU).

9. The confidential security state controller of claim 1, wherein the one or more processors, either alone or in combination, are further configured to:
indicate, to a feature register associated with a central processing unit (CPU), that the confidential security state controller supports delegation of timer IRQ handling.

10. The confidential security state controller of claim 1, wherein the one or more processors, either alone or in combination, are further configured to:
receive, from a host operating system, an indication that delegation of timer IRQ handling to the confidential security state controller is enabled.

11. A method of handling interrupt requests (IRQs), performed by a confidential security state controller, comprising:
determining, after a confidential security state exit of a virtual machine (VM), whether a pending IRQ is a timer IRQ with a VM-level processor privilege;
based on the pending IRQ being the timer IRQ with the VM-level processor privilege, activating the timer IRQ in a per-processor interrupt routing infrastructure (IRI); and
returning control to the VM.

12. The method of claim 11, wherein the per-processor IRI is associated with a central processing unit (CPU), and activating the timer IRQ is via memory-mapped register access to the per-processor IRI.

13. The method of claim 11, wherein:
based on the pending IRQ being caused by the timer, an exception caused by the pending IRQ is handled by the confidential security state controller, and does not return execution to a host operating system.

14. The method of claim 11, further comprising:
based on the pending IRQ not being caused by the timer, exiting to a host operating system.

15. The method of claim 11, further comprising:
based on the pending IRQ being caused by the timer, injecting a virtual IRQ into a per-processor interrupt virtualization state.

16. The method of claim 15, wherein the per-processor interrupt virtualization state is associated with a central processing unit (CPU) of the CCA, and the injecting is via a register of the CPU.

17. The method of claim 11, wherein:
after activating the timer IRQ in the per-processor IRI, there is no new pending IRQ; and
returning control to the VM is based on there being no new pending IRQ.

18. The method of claim 11, wherein the pending IRQ is a highest-priority pending IRQ presented to a central processing unit (CPU).

19. The method of claim 11, further comprising:
indicating, to a feature register associated with a central processing unit (CPU), that the confidential security state controller supports delegation of timer IRQ handling.

20. The method of claim 11, further comprising:
receiving, from a host operating system, an indication that delegation of timer IRQ handling to the confidential security state controller is enabled.

21. A non-transitory computer-readable medium storing computer-executable instructions that, when executed by a confidential security state controller, cause the confidential security state controller to:
determine, after a confidential security state exit of a virtual machine (VM), whether a pending IRQ is a timer IRQ with a VM-level processor privilege;
based on the pending IRQ being the timer IRQ with the VM-level processor privilege, activate the timer IRQ in a per-processor interrupt routing infrastructure (IRI); and
return control to the VM.

22. A confidential security state controller comprising:
means for determining, after a confidential security state exit of a virtual machine (VM), whether a pending IRQ is a timer IRQ with a VM-level processor privilege;
means for activating the timer IRQ in a per-processor interrupt routing infrastructure (IRI)based on the pending IRQ being the timer IRQ with the VM-level processor privilege; and
means for returning control to the VM.
